(19) United States
(12) Patent Application Publication
(10) Pub. No.: US 2003/0210211 A1
(43) Pub. Date: Nov. 13, 2003

(54) Driving circuit and method of metal-insulator-metal field emission display (MIM FED)

(75) Inventor: Seong-Hak Moon, Seoul (KR)

Correspondence Address: FLESHNER & KIM, LLP, P.O. Box 221200, Chantilly, VA, 20153-1200, US

(73) Assignee: LG Electronics Inc.

(21) Appl. No.: 10/430,419

(22) Filed: May 7, 2003

(30) Foreign Application Priority Data
May 10, 2002 (KR) 25936/2002

(51) Int. Cl. G09G 3/20; G09G 3/22

(52) U.S. Cl. 345/75.2

(57) ABSTRACT

A driving circuit and method of an MIM FED are disclosed. A luminance compensation amount is determined according to a data amount of an input image signal and/or a position of a scan line, and compensated, thereby obtaining a uniform luminance on the entire screen.

### BACKGROUND OF THE INVENTION

1. Field of the Invention

The present invention relates to a driving circuit and method of an MIM FED (metal-insulator-metal field emission display), and more particularly, to a driving circuit and method of an MIM FED capable of uniformly maintaining luminance characteristics of a display.

2. Description of the Background Art

In general, of flat panel displays in a simple matrix type, a display which needs a low voltage and a high current while having a high electrode resistance has a problem that when it is fabricated as a large scale screen and driven, left and right sections of the screen has different brightness due to a voltage drop of a scan electrode.

Among the flat panel displays in a simple matrix type, an FED (Field Emission Display) in the MIM (metal_Insulator-Metal) structure needs a low voltage and a high current compared to the general flat panel displays. Accordingly, the larger the MIM FED is, the higher electrode resistance and current are required. This unfavorably accelerates a voltage drop at the scan electrode, so that left and right sections of the screen are different in brightness.

The MIM FED will now be described in detail with reference to the accompanying drawings.

FIG. 1 shows a cell of a general MIM FED.

As shown in FIG. 1, each cell of the MIM FED includes an upper substrate 105 on which an anode electrode 107 and fluorescent materials are stacked, and a field emission array 106 formed on a lower substrate 101.

The field emission array 106 consists of a scan electrode 102 formed on the lower substrate 101, an insulation layer 103 formed on the scan electrode 102, and a data electrode 104 formed on the insulation layer 103.

A driving method of the general MIM FED constructed as described above will now be explained.

In the MIM FED, a negative (−) scan pulse is applied to the scan electrode 102 and a positive (+) data pulse is applied to the data electrode 104. A positive (+) anode voltage is applied to the anode electrode 107. Then, electrons tunnel their way to the insulation layer from the scan electrode 102 to the data electrode 104, being accelerated toward the anode electrode 107, and collide with the red, green and blue fluorescent materials to excite them. At this time, a visible ray of one of the red, green and blue is generated according to the fluorescent material and its color is displayed on the screen.

FIG. 2 is a plan view showing disposition of the data electrode and the scan electrode of the general MIM FED.

As shown in FIG. 2, in the MIM FED, the data electrodes are positioned at the upper side of the scan electrode, making a data line 201, while scan electrodes are vertically positioned at the left side in a crossing manner to the data lines 201, making a scan line 202. Since a circuit for driving the scan line 202 is disposed at the left side of the matrix form, so that as the screen is increasingly enlarged, the scan line is lengthened and a resistance is accordingly increased.

Then, a voltage difference occurs between the scan line 202 directly connected to the driving circuit and a scan line 202 positioned remote from the driving circuit, so the brightness difference is made between the left and right sections of the display screen.

FIG. 3 is a schematic block diagram of the driving circuit of the MIM FED in accordance with a conventional art.

As illustrated in FIG. 3, the FED includes an A/D converter 301 for converting input image signals (R, G, B) to a digital image signal; a scan driving unit 303 for driving the scan line; a data driving unit 302 for driving the data line, a timing controller 303 for generating various control signals for controlling the scan driving unit 304 and supplying them to the scan driving unit; and an MIM panel 305 driven by the scan driving unit 304 and the data driving unit 302 and displaying an inputted image signal on a screen.

The driving method of the MIM FED in accordance with the conventional art will now be described.

The A/D converter 301 receives vertical and horizontal synchronous signals (Vsync, Hsync) and red, green and blue image signals (R, G, B) in an analog form from an image signal supplying unit (not shown), converts them to digital image signals, and supplies them to the data driving unit 302.

In addition, the A/D converter 301 supplies a drive control signal to the timing controller 303 installed between the A/D converter 301 and the scan driving unit 304. Then, the timing controller 303 generates various control signal for controlling the scan driving unit 304 and supplies them to the scan driving unit 304, and the scan driving unit 304 supplies a scanning signal generated by the control signal of the timing controller 303 to the scan line, thereby driving the MIM panel 305.

FIG. 4 is a graph showing a luminance change according to positions on a screen in case of using the driving circuit of FIG. 3.

As shown in FIG. 4, a reference luminance should remain unchanged at every position of the screen, but an actual luminance is degraded increasingly as it goes away from the driving circuit.

In this manner, in the driving circuit of the conventional MIM FED, the R, G and B signals are simply received and converted into digital signals, which are then timing-controlled to apply a suitable voltage to each of the data electrodes through the data driving unit 302. Therefore, without a unit for compensating a voltage drop according to the increase in the resistance of the scan line, the luminance difference is made according to positions of the screen, and thus, a picture quality is deteriorated.

In an effort to solve the problem, the same driving circuits may be provided at both sides of the matrix form to drive the MIM panel 305. In this case, however, not only an integration level is degraded but also its cost increases.

In addition, when the input image signal is A/D converted and supplied to the MIM panel 305, the input signal-to-luminance ratio should have linear characteristics, but substantially it is not the case on account of the nonlinear characteristics of each FED device. The nonlinear characteristics of the devices cause a problem that a tilt of an actual luminance as shown in FIG. 4 differs by devices, so that there is a limitation in correcting the luminance uniformly.

### SUMMARY OF THE INVENTION

Therefore, an object of the present invention is to provide driving circuit and method that are capable of obtaining a uniform luminance on the entire screen by obtaining experimentally a reduction amount of a voltage according to positions of each scan line and adding the voltage reduction amount to an input image signal to compensate a luminance reduction amount according to positions of the screen.

Another object of the present invention is to provide driving circuit and method by which a compensation amount of a voltage size or a pulse width is experimentally obtained by setting different luminance compensation amounts according to data amount and used to compensate an input image signal, thereby obtaining a uniform luminance on the entire screen.

Still another object of the present invention is to provide driving circuit and its method which are advantageous for integration as well as minimize a cost increase compared to a method where a scan driving circuit is positioned at both sides of a matrix form of data lines and scan lines.

To achieve these and other advantages and in accordance with the purpose of the present invention, as embodied and broadly described herein, there is provided an MIM FED driving circuit including: an A/D converter for converting an inputted image signal to a digital image signal; a luminance compensating unit for compensating a luminance of a digital image signal according to position of a scan line; a data driving unit connected to the luminance compensating unit to receive a luminance-compensated digital image signal and drive a data line; a scan driving unit connected to the A/D converter and driving a scan line according to a certain timing control; and an MIM panel driven by the scan driving unit and the data driving unit and displaying the digital image signal on a screen.

To achieve the above objects, there is also provided an MIM FED driving method including the steps of: measuring a reduction amount of a voltage according to a position of a scan line and a data amount of a digital image signal; storing a luminance compensation amount according to the voltage reduction amount; and compensating luminance of each cell with the luminance compensation amount.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 shows a pixel of a general MIM FED;

FIG. 2 is a plan view showing a disposition of a data electrode and a scan electrode of the general MIM FED;

FIG. 3 is a schematic block diagram of a driving circuit of an MIM FED in accordance with a conventional art;

FIG. 4 is a graph showing a luminance change according to positions on a screen in case of using the driving circuit of FIG. 3;

FIG. 5 is a schematic block diagram of a driving circuit of an MIM FED in accordance with the present invention; and

FIG. 6 is a graph showing luminance characteristics according to a data amount of the MIM FED in accordance with the present invention.

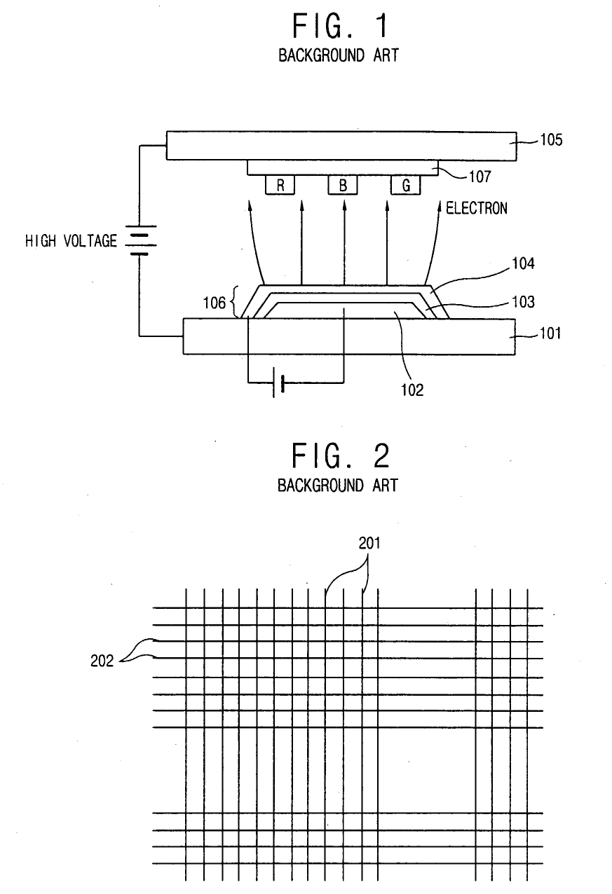

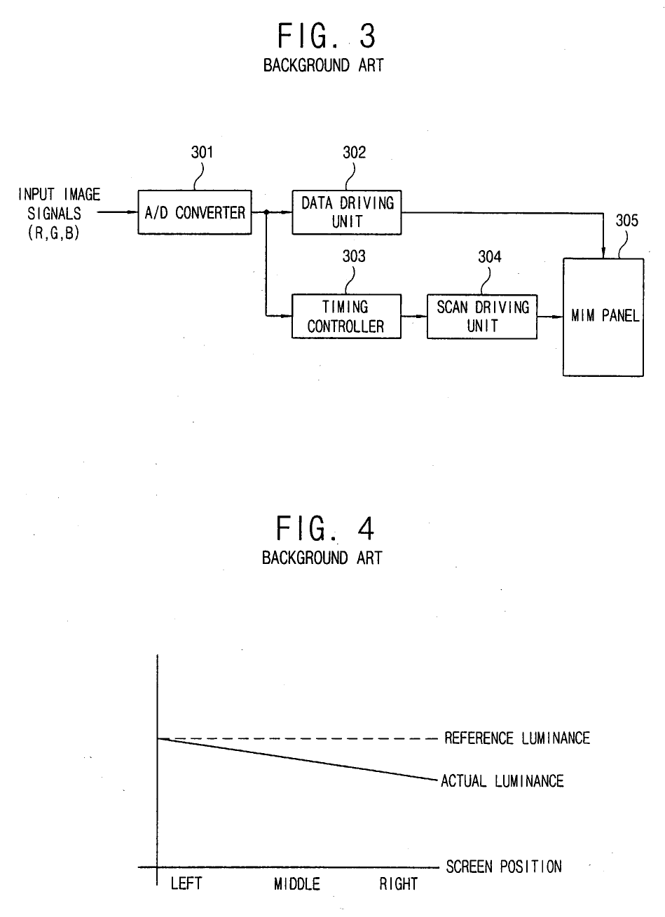

### DETAILED DESCRIPTION OF THE PREFERRED EMBODIMENTS

Reference will now be made in detail to the preferred embodiments of the present invention, examples of which are illustrated in the accompanying drawings.

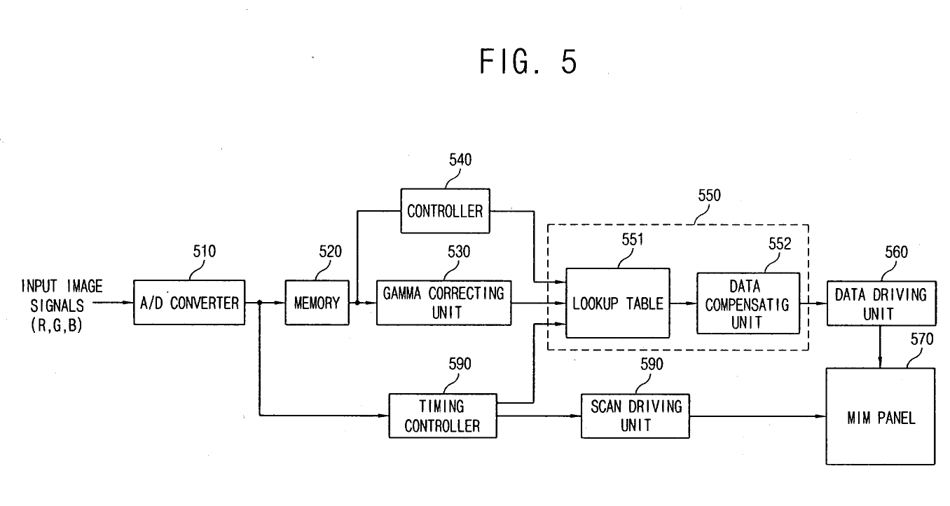

FIG. 5 is a schematic block diagram of a driving circuit of an MIM FED in accordance with the present invention.

As shown in FIG. 5, an FED of an MIM FED in accordance with the present invention includes: an A/D converter 510 for converting an inputted image signal (R, G, B) into a digital image signal; a memory 520 for temporarily storing the digital image signal supplied from the A/D converter 510; a gamma correcting unit 530 for receiving the digital image signal from the memory 520 and gamma-correcting it to adjust an entire screen brightness which is different by devices; a luminance compensating unit 550 for compensating a luminance of the gamma-corrected digital image signal according to the data amount of the digital image signal and a position of a scan line; a data driving unit 560 for receiving the digital image signal from the luminance compensating unit 550 and driving a data line; a controller 540 connected to the memory 520 and the luminance compensating unit 550, judging a data amount of one scan line stored in the memory 520 and inputting corresponding luminance compensation information to the luminance compensating unit 550; a timing controller 590 connected to the A/D converter 510, generating various control signals for controlling the scan driving unit (to be described) to supply them to the scan driving unit, and assigning an address for position information of each cell of the scan line subjected to luminance compensation and supplying the assigned address to the luminance compensating unit 550; a scan driving unit 580 for driving the scan line; and an MIM panel 570 driven by the scan driving unit 580 and the data driving unit 560 to display an inputted image signal on a screen.

The luminance compensation unit 550 consists of a lookup table 551 for receiving the judging result on the data amount of the controller 540 and storing in advance a luminance compensation amount for each cell of one scan line in consideration of positions of each cell; and a data compensating unit 552 for receiving the luminance compensation amount determined by the controller 540 and compensating luminance of each cell.

The driving method of the MIM FED of the present invention will now be described.

First, the A/D converter 510 receives red, green and blue image signals (R, G, B) and vertical horizontal synchronous signals (V, H) in an analog form from an image signal supplying unit (not shown), converts them into digital image signals and stores them in the memory 520. In addition, the A/D converter 510 supplies a driving control signal to the timing controller 590 installed between the A/D converter 510 and the scan driving unit 580.

The timing controller 590 generates various control signals for controlling the scan driving unit 580 and supplies to the scan driving unit 580, and assigns an address according to positions of the scan line subjected to luminance compensating and supplies the assigned address to the luminance compensating unit 550. Then, the scan driving unit 580 supplies a scan signal generated by a control signal of the timing controller 590 to the scan line.

The gamma correcting unit 530 gamma-corrects the input image signal according to a certain reference value so that the digital image signal of one scan line (1920 cells in case of VGA class) stored in the memory 520 may show a luminance ratio of linear characteristics for an input signal.

The controller 540 judges the data amount of the one scan line received from the memory 520 and inputs a luminance compensation amount according to the data amount to the luminance compensation unit 550.

The data amount can be classified into two or more classes. For example, the data amount of VGA class can be classified into three classes of large, medium and small depending on how many cells are turned on. That is, if more than 1280 cells are turned on, the data amount belongs to the large class, if 640-1280 cells are turned on, the data amount belongs to the medium class, while 0-639 cells are turned on, the data amount belongs to the small class.

Accordingly, if the data amount is large, the luminance reduction tilt is sharply increased, while if the data amount is small, the luminance reduction tilt is somewhat gently increased. Thus, different luminance compensation references are applied depending on the data amount. When the data amount is determined, the controller 540 inputs it to the luminance compensation unit 550.

Then, upon receiving the data amount for each cell signal (R, G or B) of one scan line, the luminance compensation unit 550 determines a luminance compensation amount corresponding to the data amount and compensates the luminance of the digital image signal by positions of each cell.

In detail, the lookup table 551 measures a reduction amount of a voltage according to the position of scan line and the data amount and stores the compensation amount corresponding to the voltage reduction amount by positions of each cell. In the lookup table 551, because the address is set for every cell by the timing controller 590, luminance compensation can be possibly made by positions of each cell.

The data compensating unit 552 subtracts or adds the compensation amount corresponding to each cell according to positions on the screen. At this time, the method for compensating the luminance of R, G and B signals uses one of a voltage control (PAM) or a pulse width control (PWM) as selected.

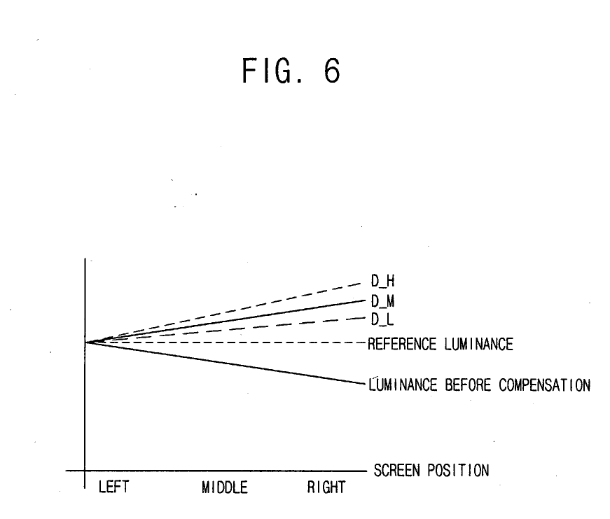

FIG. 6 is a graph showing luminance characteristics according to a data amount of the MIM FED in accordance with the present invention.

As shown in FIG. 6, if the data amount belongs to the medium class, a luminance compensation amount corresponding to D_M is selected. The luminance compensation amount is a voltage value for compensating a voltage drop according to positions on the screen and stored in the lookup table 551 in advance. The luminance compensation amount stored in the lookup table 551 is added to or subtracted from each cell signal outputted from the gamma correcting unit 530 and outputted to the data driving unit 560. As shown in FIG. 6, the output shows a reference luminance tilt, that is, a luminance in a constant state without a tilt.

Meanwhile, if the data amount of one scan line is judged to be large, a luminance compensation amount corresponding to D_H is selected. If, however, the data amount is judged to be small, a luminance compensation amount corresponding to D_L is selected. In this manner, uniform luminance characteristics can be obtained for the entire screen.

As so far described, the driving circuit and method of the MIM FED of the present invention has many advantages.

That is, the reduction amount of the voltage according to positions of each scan line is obtained experimentally, which is added to an input image signal to compensate the reduction amount of luminance according to the position on the screen, so that a uniform luminance can be obtained for the entire screen.

In addition, a voltage size or a compensation amount of a pulse width are experimentally obtained by setting different luminance compensation amounts for data amounts and used for compensating an input image signal, thereby obtaining uniform luminance on the entire screen.

Moreover, compared to the method where the driving circuit is positioned at both sides of the matrix form, in the present invention, cost increase is minimized and it is more suitable for integration.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An MIM FED driving circuit comprising:
an A/D converter for converting an inputted image signal to a digital image signal;
a luminance compensating unit for compensating a luminance of a digital image signal according to position of a scan line;
a data driving unit connected to the luminance compensating unit to receive a luminance-compensated digital image signal and drive a data line;
a scan driving unit connected to the A/D converter and driving a scan line according to a certain timing control; and
an MIM panel driven by the scan driving unit and the data driving unit and displaying the digital image signal on a screen.

2. The circuit of claim 1, wherein the luminance compensating unit stores a luminance reduction amount according to a position of a scan line through an experiment in advance and compensates a luminance by adding a luminance compensation amount to the digital image signal on the basis of the reduction amount.

3. The circuit of claim 1 further comprising:
receiving the A/D converted digital image signal and gamma-correcting it to adjust the entire screen brightness which is different by devices.

4. A driving circuit of an MIM FED comprising:
an A/D converter for converting an inputted image signal (R, G, B) into a digital image signal;
a gamma correcting unit for gamma-correcting the digital image signal to adjust an entire screen brightness which is different by devices;
a luminance compensating unit for compensating luminance of the digital image signal according to a data amount of the digital image signal;
a data driving unit for receiving the luminance-compensated digital image signal by being connected to the luminance compensating unit, and driving a data line;
a controller connected to the luminance compensating unit, judging a data amount of the digital image signal supplied from the A/D converter and applying corresponding luminance compensation information to the luminance compensating unit;
a timing controller connected to the A/D converter, generating various control signals for driving the scan line, and assigning an address for position information of each cell of the scan line to supply the assigned address to the luminance compensating unit;
a scan driving unit for driving the scan line according to a timing control by the timing controller; and
an MIM panel driven by the scan driving unit and the data driving unit and displaying an inputted image signal on a screen.

5. The circuit of claim 4, wherein the luminance compensating unit comprises:
a lookup table for storing a luminance compensation amount according to the data amount obtained through an experiment in advance for each cell signal; and
a data compensating unit for subtracting or adding the luminance compensation amount of each cell with reference to the lookup table.

6. The circuit of claim 5, wherein the data compensating unit uses one method of voltage control (PAM) or a pulse width control (PWM) to calculate the luminance compensation amount of each cell.

7. The circuit of claim 4, wherein the data amount is determined depending on how many cells of one scan line are turned on.

8. The circuit of claim 4, wherein the controller classifies a data amount of the digital image signal into at least two or more classes according to how large the digital image signal is.

9. An MIM FED driving circuit comprising:
an A/D converter for converting an inputted image signal into a digital image signal;
a memory for temporarily storing the digital image signal supplied from the A/D converter by the unit of an image signal corresponding to one scan line;
a gamma correcting unit for receiving the digital image signal stored in the memory by the unit of the image signal corresponding to one scan line and gamma-correcting it to adjust the entire screen brightness which is different by devices;
a luminance compensating unit for compensating luminance of the digital image signal according to a position of the scan line and a data amount of the digital image signal;
a controller connected to the memory and the luminance compensating unit, judging the data amount of one scan line stored in the memory, and applying luminance compensation information according to the data amount to the luminance compensating unit;
a timing controller connected to the A/D converter, generating various control signals for controlling the scan driving unit to supply them to the scan driving unit, and assigning an address for position information of each cell of the scan line subjected to luminance compensation and supplying the assigned address to the luminance compensating unit;
a data driving unit for receiving the digital image signal by being connected to the luminance compensating unit, and driving a data line;
scan driving unit for driving a scan line according to a timing control by the timing controller; and
an MIM panel driven by the scan driving unit and the data driving unit and displaying the luminance-compensated digital image signal on a screen.

10. The circuit of claim 9, wherein the luminance compensating unit comprises:
determining a luminance tilt on the basis of a data amount applied from the controller and a luminance reduction amount according to a position of the scan line, and storing in advance luminance compensation amounts for each cell of one scan line on the basis of the luminance tilt according to positions of each cell; and
a data compensating unit for receiving the luminance compensation amount according to the positions of each cell from the lookup table and compensating each luminance of each cell.

11. The circuit of claim 10, wherein the data compensating unit the data compensating unit uses one method of a voltage control (PAM) and a pulse width control (PWM) as selected in order to calculate the luminance compensation amount of each cell.

12. The circuit of claim 9, wherein the data amount is determined depending on how many cells of one scan line are turned on.

13. The circuit of claim 9, wherein the controller classifies a data amount of the digital image signal into at least two or more classes according to how large the digital image signal is.

14. An MIM FED driving method comprising the steps of:
measuring a reduction amount of a voltage according to a position of a scan line and a data amount of a digital image signal;
storing a luminance compensation amount according to the voltage reduction amount; and
compensating luminance of each cell with reference to the luminance compensation amount.

15. The method of claim 14, wherein, in the storing step, the luminance compensation amount is stored by positions of each cell.

16. The method of claim 14, wherein, in the compensating step, the luminance is compensated by modulating a pulse width or by controlling a voltage.
